(19) United States
(12) Patent Application Publication
(10) Pub. No.: US 2026/0008319 A1
(43) Pub. Date: Jan. 8, 2026

(54) VEHICLE AIR CONDITIONING SYSTEM

(71) Applicant: NGK INSULATORS, LTD., Nagoya-City (JP)

(72) Inventor: Takafumi HAMADA, Nagoya-Shi (JP)

(73) Assignee: NGK INSULATORS, LTD., Nagoya-City (JP)

(21) Appl. No.: 19/216,940

(22) Filed: May 23, 2025

(30) Foreign Application Priority Data
Jul. 4, 2024 (JP) 2024-108377

(51) Int. Cl. B60H 1/00

(52) U.S. Cl. CPC B60H 1/00664

(57) ABSTRACT

A vehicle air conditioning system includes: at least one air conditioning device comprising an adsorption portion, and a heating means configured to heat the adsorption portion; an air conditioning duct having the air conditioning device provided therein and allowing air from a vehicle interior or a vehicle exterior to flow therethrough, the air conditioning duct having a first flow path for allowing the air to flow into the vehicle interior on a downstream side of the air conditioning device and a second flow path for discharging the air to the vehicle exterior; a valve configured to switch the flow of the air between the first flow path and the second flow path; and a control unit for controlling the air conditioning device and the valve.

### CROSS REFERENCE TO RELATED APPLICATIONS

This application claims the benefit of priority to Japanese Patent Application No 2024-108377 filed on Jul. 4, 2024 with the Japanese Patent Office, the entire contents of which are incorporated herein by reference in its entirety.

### FIELD OF THE INVENTION

This disclosure relates to a vehicle air conditioning system.

### BACKGROUND OF THE INVENTION

In various types of vehicles such as automobiles, there are increasing requirements for improvement of vehicle interior environment. Specific requirements illustrate reduction of an amount of carbon dioxide in the vehicle interior to suppress driver's drowsiness, control of humidity in the vehicle interior, and removal of harmful volatile components such as odor components and allergy-causing components in the vehicle interior. The effective measure for such requirements includes ventilation, but the ventilation causes a large loss of heater energy in winter, leading to a decreased energy efficiency in winter. In particular, a battery electric vehicle (BEV) has a problem that its cruising range is significantly reduced due to its energy loss.

Therefore, Patent Literature 1 proposes a vehicle air conditioning (air purifying) system including: a first flow path and a second flow path that are in communication with a vehicle interior; and an adsorption block located in each flow path. The adsorption block uses an adsorption material (zeolite) that can adsorb carbon dioxide and water vapor contained in air as adsorption target substances (purification target substances) and desorb the adsorption target substances when heated air passes through it. The first flow path and the second flow path branch downstream of the adsorption block into a flow path that is in communication with the vehicle interior and a flow path that is in communication with the outside of the vehicle interior, and a valve (switching mechanism) is provided in one of these flow paths to switch the flow of the air. According to the vehicle air conditioning system, it is possible to achieve simultaneously an operation in which one adsorption block adsorbs the adsorption target substances and returns the purified air to the vehicle interior, and an operation in which the other adsorption block can discharge the air that has desorbed the adsorption target substances to the outside of the vehicle interior, and also prevent unpurified air from flowing into the vehicle interior.

The adsorbent (adsorption material) capable of adsorbing and desorbing the adsorption target substances described in Patent Literature 1 can adsorb the adsorbent target substances at or below a predetermined temperature and desorb the adsorption target substances when the temperature exceeds the predetermined temperature. Therefore, even if the state where the adsorbent target substances are adsorbed is switched to the state where the absorbent target substances are desorbed, the state where the absorbent target substances are adsorbed is maintained during the period until the temperature of the adsorbent exceeds the predetermined temperature. In the conventional vehicle air conditioning system as described in Patent Literature 1, the timing for heating the adsorbent and the timing for switching the valve to allow the air to flow into the flow path to the vehicle exterior were the same, so that there was a waste that the air with reduced or removed adsorption target substances is discharged to the vehicle exterior during the period until the temperature of the adsorbent exceeds the predetermined temperature.

This disclosure has been made to solve the above problems, and an object of this disclosure is to provide a vehicle air conditioning system that can be switched from the state where the adsorption target substances are adsorbed to a state where the adsorption target substances are desorbed, without wasting the air with reduced or removed adsorption target substances.

### PRIOR ART

### Patent Literature

[Patent Literature 1] Japanese Patent Application Publication No. 2020-104774 A

### SUMMARY OF THE INVENTION

As a result of intensive studies for vehicle air conditioning systems provided with air conditioning devices, the inventor of this application has found that the above problems can be solved by controlling a valve so that the air flows to the vehicle exterior when a temperature of an adsorption portion exceeds a predetermined temperature when an adsorption mode where a heating means of the air conditioning device is not activated is shifted to a desorption mode where the heating means of the air conditioning device is activated, and thus arrived at one or more embodiments of the disclosure. In other words, the embodiments are exemplified as follows:

<1> A vehicle air conditioning system, comprising:
at least one air conditioning device comprising an adsorption portion containing an adsorbent configured to adsorb absorbent target substances at a temperature lower than or equal to a predetermined temperature and to desorb the adsorption target substances when the temperature exceeds the predetermined temperature, and a heating means configured to heat the adsorption portion;
an air conditioning duct having the air conditioning device provided therein and allowing air from a vehicle interior or a vehicle exterior to flow therethrough, the air conditioning duct having a first flow path for allowing the air to flow into the vehicle interior on a downstream side of the air conditioning device and a second flow path for discharging the air to the vehicle exterior;
a valve configured to switch the flow of the air between the first flow path and the second flow path; and
a control unit for controlling the air conditioning device and the valve,
wherein the control unit is configured to execute an adsorption mode where the heating means of the air conditioning device is not activated, and a desorption mode where the heating means of the air conditioning device is activated, and
wherein the control unit switches the valve so that the air flows into the second flow path at a stage when the temperature of the adsorption portion exceeds the predetermined temperature as the adsorption mode is shifted to the desorption mode.

<2> The vehicle air conditioning system according to <1>, wherein the control unit may switch the valve so that the air flows into the first flow path at a stage when the temperature of the adsorption portion is lower than or equal to the predetermined temperature as the desorption mode is shifted to the adsorption mode.

<3> The vehicle air conditioning system according to <1> to <2>, wherein the switching of the valve as the adsorption mode is shifted to the desorption mode may take place within 60 seconds from the start of the desorption mode.

<4> The vehicle air conditioning system according to any one of <1> to <3>, wherein the switching of the valve as the desorption mode is shifted to the adsorption mode may take place within 60 seconds from the start of the adsorption mode.

<5> The vehicle air conditioning system according to any one of <1> to <4>, wherein the adsorption mode and the desorption mode may be repeatedly and sequentially executed.

<6> The air conditioning system according to any one of <1> to <5>, wherein the air conditioning device may include:
a honeycomb structure having an outer peripheral wall and partition walls provided on an inner side of the outer peripheral wall, the partition walls defining a plurality of cells, each of the cells extending from a first end face to a second end face of the honeycomb structure to form a flow path for the air;
an adsorption layer comprising the adsorbent, the adsorption layer being provided on a surface of each of the partition walls; and
a pair of electrodes provided on the first end face and the second end face of the honeycomb structure, or on the outer peripheral wall parallel to the extending direction of the cells of the honeycomb structure.

<7> The vehicle air conditioning system according to <6>, wherein a temperature of the adsorption layer may be obtained by previously determining a relationship between at least one condition parameter and the temperature of the adsorption layer, the at least one condition parameter being selected from a temperature of the honeycomb structure, a resistance value of the honeycomb structure, a current value of the honeycomb structure, a heating time of the honeycomb structure, a temperature of the air passing through the honeycomb structure, and amounts of components contained in the air passing through the honeycomb structure, and then measuring the condition parameter.

<8> The vehicle air conditioning system according to <6> or <7>, which may further include a power source for applying voltage to the air conditioning device.

<9> The vehicle air conditioning system according to any one of <6> to <8>, wherein at least the partition walls of the honeycomb structure may be made of a material having a PTC property.

<10> The vehicle air conditioning system according to any one of <6> to <9>, wherein the adsorbent may adsorb at least one of moisture, carbon dioxide and volatile components.

### BRIEF DESCRIPTION OF THE DRAWINGS

FIG. 1 is an overall schematic configuration view of a vehicle air conditioning system according to an embodiment;

FIG. 2 is a graph illustrating a relationship between a temperature and a time for an adsorption portion of an air conditioning device;

FIG. 3A is a schematic view of a cross section of a typical air conditioning device used in a vehicle air conditioning system according to an embodiment, which is parallel to a flow path direction; and

FIG. 3B is a schematic cross-sectional view of the air conditioning device in FIG. 3A taken along the line a-a′.

### DETAILED DESCRIPTION OF THE INVENTION

A vehicle air conditioning system according to this disclosure includes: at least one air conditioning device including an adsorption portion containing an adsorbent configured to adsorb absorbent target substances at a temperature lower than or equal to a predetermined temperature and to desorb the adsorption target substances when the temperature exceeds the predetermined temperature, and a heating means configured to heat the adsorption portion; an air conditioning duct having the air conditioning device provided therein and allowing air from a vehicle interior or a vehicle exterior to flow therethrough, the air conditioning duct having a first flow path for allowing the air to flow into the vehicle interior on a downstream side of the air conditioning device and a second flow path for discharging the air to the vehicle exterior; a valve configured to switch the flow of the air between the first flow path and the second flow path; and a control unit for controlling the air conditioning device and the valve. The control unit is configured to execute an adsorption mode where the heating means of the air conditioning device is not activated, and a desorption mode where the heating means of the air conditioning device is activated. Also, the control unit switches the valve so that the air flows into the second flow path at a stage when the adsorption portion exceeds the predetermined temperature as the adsorption mode is shifted to the desorption mode. By configuring the vehicle air conditioning system according to this disclosure in such a manner, the air with reduced or removed adsorption target substances can be flowed into the vehicle interior during the period until the temperature of the adsorbent exceeds a predetermined temperature, so that it possible to switch from a state where the adsorption target substances are adsorbed to a state where the adsorption target substances are desorbed, without wasting the air with reduced or removed adsorption target substances.

Hereinafter, embodiments of this disclosure will be specifically described with reference to the drawings. It should be understood that the disclosure is not limited to the following embodiments, and those which have appropriately added changes, improvements and the like to the following embodiments based on knowledge of a person skilled in the art without departing from the spirit of the disclosure fall within the scope of the disclosure.

The vehicle air conditioning system according to an embodiment can be suitably utilized for various vehicles such as automobiles. The vehicle includes, but not limited to, automobiles and electric rail cars. Non-limiting examples of the automobile include a gasoline vehicle, a diesel vehicle, a gas fuel vehicle using CNG (compressed natural gas) or LNG (liquefied natural gas), a fuel cell vehicle, an electric vehicle, and a plug-in hybrid vehicle. In particular, the vehicle air conditioning system according to an embodiment can be suitably used for a vehicle that has no internal combustion engine such as electric vehicles and electric rail cars.

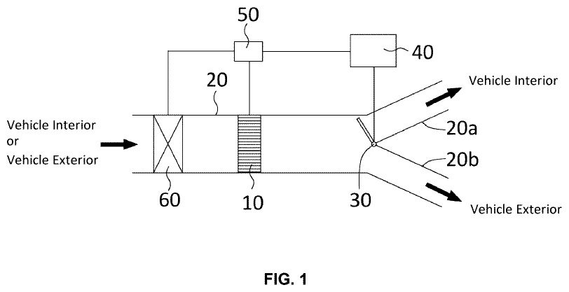

FIG. 1 is an overall schematic configuration view of a vehicle air conditioning system according to an embodiment.

As illustrated in FIG. 1, a vehicle air conditioning system according to an embodiment includes: an air conditioning device 10; an air conditioning duct 20; a valve 30; and a control unit 40. Further, the vehicle air conditioning system can further include: a power source 50; and a ventilation fan 60.

The vehicle air conditioning system includes: at least one air conditioning device including an adsorption portion containing an adsorbent configured to adsorb absorbent target substances at a temperature lower than or equal to a predetermined temperature and to desorb the adsorption target substances when the temperature exceeds the predetermined temperature, and a heating means configured to heat the adsorption portion.

As used herein, the “predetermined temperature” means a boundary temperature between an upper limit of the temperature at which the adsorption portion can adsorb the adsorption target substances and a lower limit of the temperature at which the adsorption portion can desorb the adsorption target substances. Therefore, the “predetermined temperature” of the adsorption portion is determined depending on the adsorbent (adsorbent material) used in the adsorption portion and the type of adsorption target substances.

The air conditioning duct 20 has the air conditioning device 10 provided therein and can allow the air from the vehicle interior or the vehicle exterior to flow therethrough. The air conditioning duct 20 can have, on a downstream side of the air conditioning device 10, a first flow path 20a that allows the air to flow into the vehicle interior, and a second flow path 20b that allows the air to be discharged to the vehicle exterior.

The valve 30 may be configured to switch the flow of the air between the first flow path 20a and the second flow path 20b.

The control unit 40 can control the air conditioning device 10 and the valve 30. Also, the control unit 40 is configured to execute an adsorption mode where the heating means of the air conditioning device 10 is not activated, and a desorption mode where the heating means of the air conditioning device 10 is activated.

In the vehicle air conditioning system having the above structure, when the air from the vehicle interior or vehicle exterior flows through the air conditioning duct 20, the adsorption or desorption of the adsorption target substances can be performed in the air conditioning device 10. When the adsorption target substances are adsorbed in the air conditioning device 10, the air conditioning device 10 is set to an adsorption mode where the heating means is not activated, so that the adsorption portion is maintained at a temperature lower than or equal to the predetermined temperature. The air that has reduced or removed the adsorption target substances in the air conditioning device 10 (adsorption portion) can be allowed to flow into the vehicle interior by switching the valve 30 so that it flows into the first flow path 20a. On the other hand, when the adsorption target substances are desorbed in the air conditioning device 10, it is set to the desorption mode where the heating means of the air conditioning device 10 is activated, so that the adsorption portion is heated at a temperature higher than the predetermined temperature. The air containing the adsorption target substances desorbed from the air conditioning device 10 (adsorption portion) can be discharged to the vehicle exterior by switching the valve 30 so that it flows into the second flow path 20b.

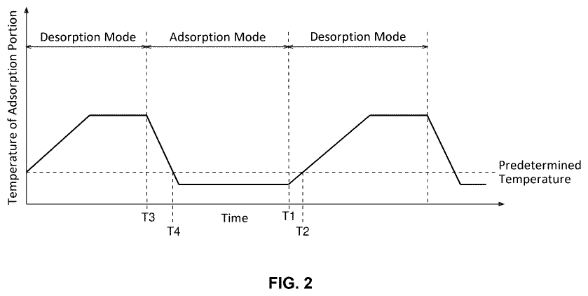

Here, FIG. 2 illustrates a graph showing a relationship between a temperature and a time for an adsorption portion of an air conditioning device.

In FIG. 2, the adsorption mode where the heating means of the air conditioning device 10 is not activated is in a state where the heating of the adsorption portion of the air conditioning device 10 is stopped. The desorption mode, which activates the heating means of the air conditioning device 10, is in a state where the heating of the adsorption portion of the air conditioning device 10 is being executed. As illustrated in FIG. 2, in the desorption mode, the temperature of the adsorption portion of the air conditioning device 10 exceeds the predetermined temperature over time (when time T2 has elapsed), but in the initial phase (between time T1 and T2) it is lower than or equal to the predetermined temperature. Therefore, if the valve 30 is switched simultaneously so that the air flows into the second flow path 20b when the adsorption mode is shifted to the desorption mode, there is a waste that the air with reduced or removed desorption target substances is discharged to the vehicle exterior during the period until the temperature of the adsorption portion exceeds the predetermined temperature (between time T1 and T2).

So, when the adsorption mode is shifted to the desorption mode, the control unit 40 switches the valve 30 so that the air flows into the second flow path 20b at the stage when the adsorption portion exceeds the predetermined temperature (at the stage when time T2 has elapsed). This control allows the air with reduced or removed adsorption target substances to flow into the vehicle interior without any waste during the period until the temperature of the adsorption portion exceeds the predetermined temperature (between times T1 and T2).

The switching of the valve 30 when the adsorption mode is shifted to the desorption mode preferably takes place within 60 seconds from the start of the desorption mode, more preferably between 1 and 55 seconds, and even more preferably between 2 and 50 seconds. By switching the valve 30 at such timing, the shifting from the adsorption mode to the desorption mode can proceed smoothly while minimizing the waste of the air with reduced or removed adsorption target substances.

As illustrated in FIG. 2, in the adsorption mode, the temperature of the adsorption portion of the air conditioning device 10 is lower than or equal to the predetermined temperature over time (when time T4 has elapsed), but in the initial phase (between time T3 and T4) the temperature is higher than the predetermined temperature. Therefore, if the valve 30 is switched simultaneously so that the air flows into the first flow path 20a when the desorption mode is shifted to the adsorption mode, the air containing the desorption target substances will flow into the vehicle interior during the period until the temperature of the adsorption portion is lower than or equal to the predetermined temperature (between time T3 and T4).

So, when the desorption mode is shifted to the adsorption mode, the control unit 40 switches the valve 30 so that the air flows into the first flow path 20a at the stage when the adsorption portion is lower than or equal to the predetermined temperature (at the stage when time T4 has elapsed). Such control allows the air containing the adsorption target substances to be discharged to the vehicle exterior during the period until the adsorption portion is lower than or equal to the predetermined temperature (between time T3 and T4).

The switching of the valve 30 when the desorption mode is shifted to the adsorption mode preferably takes place within 60 seconds from the start of the adsorption mode, more preferably between 1 and 55 seconds, and even more preferably between 2 and 50 seconds. By switching the valve 30 at such timing, the shifting from the desorption mode to the adsorption mode can proceed smoothly while preventing the air containing the desorption target substances from entering the vehicle interior.

The adsorption mode and the desorption mode can be executed as needed depending on the concentration of the adsorption target substances in the vehicle interior and the like, and when the concentration of the adsorption target substances in the vehicle interior is higher, it is preferable that the adsorption mode and the desorption mode are repeatedly and sequentially executed. By repeating the adsorption mode and the desorption mode, even if the amount of the adsorption target substances adsorbed on the air conditioning device 10 (adsorption portion) is saturated, the air conditioning device 10 can be regenerated in the desorption mode and the adsorption target substances are then immediately adsorbed in the adsorption mode, thus enabling efficient air conditioning in the vehicle interior.

Each component of the vehicle air conditioning system will be described below in detail.

### (1. Air Conditioning Device 10)

The air conditioning device 10 is not particularly limited as long as it includes an adsorption portion containing an adsorbent configured to adsorb absorbent target substances at a temperature lower than or equal to a predetermined temperature and to desorb the adsorbent target substances when the temperature exceeds the predetermined temperature, and a heating means configured to heat the adsorption portion.

Also, the number of air conditioning devices 10 provided in the air conditioning duct 20 may be one or more than one. When more than one air conditioning devices 10 are provided, they may be arranged in parallel to or in series with the flow of the air flowing through the air conditioning duct 20.

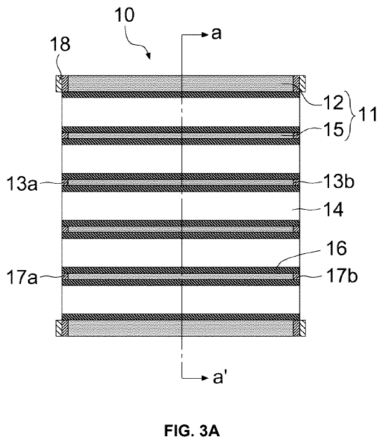

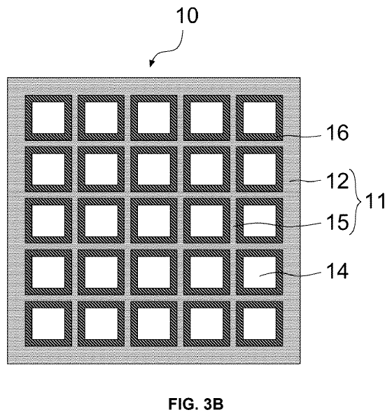

FIG. 3A is a schematic view of a cross section of a typical air conditioning device used in a vehicle air conditioning system according to an embodiment, which is parallel to a flow path direction. FIG. 3B is a schematic cross-sectional view of the air conditioning device in FIG. 3A taken along the line a-a′.

The air conditioning device 10 as illustrated in FIGS. 3A and 3B includes: a honeycomb structure 11 having an outer peripheral wall 12 and partition walls 15 provided on an inner side of the outer peripheral wall 12, the partition walls 15 defining a plurality of cells 14 each extending from a first end face 13a to a second end face 13b of the honeycomb structure 11 to form a flow path for air; an adsorption layer 16 containing an adsorbent, the adsorption layer 16 being provided on a surface of each of the partition walls 15; and a pair of electrodes 17a, 17b provided on the first end face 13a and the second end face 13b of the honeycomb structure 11, respectively. Although not illustrated, the pair of electrodes 17a, 17b may be provided on the outer peripheral wall 12 parallel to the extending direction of the cells 14 of the honeycomb structure 11. Also, Terminals 18 may be connected to the pair of electrodes 17a, 17b, respectively.

### (1-1. Honeycomb Structure 11)

The shape of the honeycomb structure 11 is not particularly limited. For example, an outer shape of a cross section of the honeycomb structure 11 orthogonal to the flow path direction (extending direction of the cells 14) can be polygonal such as quadrangular (rectangular, square), pentagonal, hexagonal, heptagonal, and octagonal, circular, oval (egg-shaped, elongated circular, elliptical, rounded rectangular, etc.), or the like. The end faces (first end face 13a and second end face 13b) have the same shape as the cross section. Also, when the cross section and the end faces are polygonal, the corners may be chamfered.

The shape of each cell 14 is not particularly limited, but it may be polygonal such as quadrangular, pentagonal, hexagonal, heptagonal, and octagonal, circular, or oval in the cross section of the honeycomb structure 11 orthogonal to the flow path direction. These shapes may be alone or in combination of two or more. Moreover, among these shapes, the quadrangle or the hexagon is preferable. By providing the cells 14 having such a shape, it is possible to reduce the pressure loss when the air flows.

The honeycomb structure 11 may be a honeycomb joined body that includes a plurality of honeycomb segments and joining layers that join outer peripheral side surfaces of the plurality of honeycomb segments together. The use of the honeycomb joined body can increase the total cross-sectional area of the cells 14, which is important for ensuring the flow rate (flow velocity) of the air, while suppressing cracking.

It should be noted that the joining layer can be formed by using a joining material. The joining material is not particularly limited, but a ceramic material obtained by adding a solvent such as water to form a paste can be used. The joining material may contain a material having a PTC property, or may contain the same material as the outer peripheral wall 12 and the partition walls 15. In addition to the role of joining the honeycomb segments to each other, the joining material can also be used as an outer peripheral coating material after joining the honeycomb segments.

From the viewpoints of ensuring the strength of the honeycomb structure 11, reducing a pressure loss when the air passes through the cells 14, ensuring the amount of the adsorbent supported, and ensuring the contact area with the air flowing inside the cells 14, it is desirable to suitably combine a thickness of the partition wall 15, a cell density, and a cell pitch (or an opening ratio of the cells 14).

As used herein, the cell density refers to a value obtained by dividing a number of cells by an area of one end face (first end face 13a or second end face 13b) of the honeycomb structure 11 (the total area of the partition walls 15 and the cells 14 excluding the outer peripheral wall 12).

As used herein, the cell pitch refers to a value obtained by the following calculation. First, the area of one end face (first end face 13a or second end face 13b) of the honeycomb structure 11 (the total area of the partition walls 15 and the cells 14 excluding the outer peripheral wall 12) is divided by the number of the cells to calculate an area per a cell. A square root of the area per a cell is then calculated, and this is determined to be the cell pitch.

As used herein, the opening ratio of the cells 14 refers a value obtained by dividing the total area of the cells 14 defined by the partition walls 15 by the area of one end face (first end face 13a or second end face 13b) (the total area of the partition walls 15 and the cells 14 excluding the outer peripheral wall 12) in the cross section orthogonal to the flow path direction of the honeycomb structure 11. It should be noted that when calculating the opening ratio of the cells 14, the pair of electrodes 17a, 17b, and the adsorption layer 16 are not taken into account.

In an embodiment that is advantageous from the viewpoint of supporting a sufficient amount of functional material, the thickness of the partition walls 15 is 0.300 mm or less, the cell density is 100 cells/cm² or less, and the cell pitch is 1.0 mm or more. In a preferred embodiment, the thickness of the partition walls 15 is 0.200 mm or less, the cell density is 70 cells/cm² or less, and the cell pitch is 1.2 mm or more. In a more preferred embodiment, the thickness of the partition walls 15 is 0.130 mm or less, the cell density is 65 cells/cm² or less, and the cell pitch is 1.3 mm or more.

From the viewpoints of ensuring the strength of the honeycomb structure 11 and maintaining lower electrical resistance, the lower limit of the thickness of the partition wall 15 is preferably 0.010 mm or more, more preferably 0.020 mm or more, and even more preferably 0.030 mm or more.

From the viewpoints of ensuring the strength of the honeycomb structure 11, maintaining lower electrical resistance, and increasing a surface area to facilitate reaction, adsorption, and separation, the lower limit of the cell density is 30 cells/cm² or more, and preferably 35 cells/cm² or more, and even more preferably 40 cells/cm² or more.

From the viewpoints of ensuring the strength of the honeycomb structure 11, maintaining lower electrical resistance and increasing a surface area to facilitate reaction, adsorption and separation, the upper limit of the cell pitch is 2.0 mm or less, more preferably 1.8 mm or less, and even more preferably 1.6 mm or less.

In an embodiment that is advantageous in terms of both reducing pressure loss and maintaining strength, the thickness of the partition walls 15 is 0.08 to 0.36 mm, the cell density is 2.54 to 140 cells/cm², and the opening ratio of the cells 14 is 0.70 or more. In a preferred embodiment, the thickness of the partition walls 15 is 0.09 to 0.35 mm, the cell density is 15 to 100 cells/cm², and the opening ratio of the cells 14 is 0.80 or more. In a more preferred embodiment, the thickness of the partition walls 15 is 0.14 to 0.30 mm, the cell density is 20 to 90 cells/cm², and the opening ratio of the cells 14 is 0.85 or more.

From the viewpoint of ensuring the strength of the honeycomb structure 11, the upper limit of the opening ratio of the cells 14 is preferably 0.94 or less, more preferably 0.92 or less, and even more preferably 0.90 or less.

Although the thickness of the outer peripheral wall 12 is not particularly limited, it is preferably determined based on the following considerations. First, from the viewpoint of reinforcing the honeycomb structure 11, the thickness of the outer peripheral wall 12 is preferably 0.05 mm or more, more preferably 0.06 mm or more, and even more preferably 0.08 mm or more. On the other hand, when the viewpoint of suppressing the initial current by increasing the electrical resistance and from the viewpoint of reducing pressure loss when air flows are considered, the thickness of the outer peripheral wall 12 is preferably 1.0 mm or less, more preferably 0.5 mm, even more preferably 0.4 mm or less, and still more preferably 0.3 mm or less.

As used herein, the thickness of the outer peripheral wall 12 refers to a length, in a normal line direction of a side surface of the honeycomb structure 11, from a boundary between the outer peripheral wall 12 and the outermost cell 14 or the partition wall 15 to the side surface of the honeycomb structure 11 in the cross section orthogonal to the flow path direction of the honeycomb structure 11.

The length of the honeycomb structure 11 in the flow path direction and the cross-sectional area of the honeycomb structure 11 orthogonal to the flow path direction may be adjusted according to the required size of the air conditioning device 10, and are not particularly limited. For example, when used in a compact air conditioning device 10 while ensuring a predetermined function, the honeycomb structure 11 can have a length of 2 to 20 mm in the flow path direction and have a cross-sectional area of 10 cm² or more orthogonal to the flow path direction. Although the upper limit of the cross-sectional area orthogonal to the flow path direction is not particularly limited, it is, for example, 300 cm² or less.

The partition walls 15 forming the honeycomb structure 11 are preferably made of a material that can be heated by electric conduction, specifically made of a material having a PTC property. Further, the outer peripheral wall 12 may also be made of a material having a PTC property, as with the partition walls 15, as needed. By such a configuration, the adsorption layer 16 can be directly heated by heat transfer from the heat-generating partition walls 15 (and optionally the outer peripheral wall 12). Further, the material having the PTC property has characteristics such that when the temperature increases to exceed the Curie point, the resistance value is sharply increased, making it difficult for electricity to flow. Therefore, when the temperature of the partition walls 15 (and the outer peripheral wall 12 if necessary) becomes high, the current flowing through them is limited, thereby suppressing excessive heat generation of the honeycomb structure 11. Therefore, it is possible to suppress thermal deterioration of the adsorption layer 16 due to excessive heat generation.

From the viewpoint of obtaining appropriate heat generation, the lower limit of the volume resistivity at 25° C. of the material having the PTC property is preferably 0.5 Ω·cm or more, and more preferably 1 Ω·cm or more, and even more preferably 5 Ω·cm or more. From the viewpoint of generating heat with a low driving voltage, the upper limit of the volume resistivity at 25° C. of the material having the PTC property is preferably 30 Ω·cm or less, and more preferably 18 Ω·cm or less, and even more preferably 16 Ω·cm or less. As used herein, the volume resistivity at 25° C. of the material having the PTC property is measured according to JIS K 6271: 2008.

From the viewpoints of creating a device that can be heated by electric conduction and have the PTC property, the outer peripheral wall 12 and the partition walls 15 are preferably made of a material containing barium titanate (BaTiO₃) as a main component. Also, this material is more preferably ceramics made of a material containing barium titanate (BaTiO₃)-based crystals as a main component in which a part of Ba is substituted with a rare earth element. As used herein, the term “main component” means a component in which a proportion of the component is more than 50% by mass of the total component. The content of BaTiO₃-based crystalline particles can be determined by fluorescent X-ray analysis. Other crystalline particles can be measured in the same manner as this method.

The compositional formula of BaTiO₃-based crystalline particles, in which a part of Ba is substituted with the rare earth element, can be expressed as (Ba₁₋ₓAₓ)TiO₃. In the compositional formula, the symbol A represents at least one rare earth element, and 0.001≤x≤0.010.

The symbol A is not particularly limited as long as it is the rare earth element, but it may preferably be one or more selected from the group consisting of La, Ce, Pr, Nd, Eu, Gd, Dy, Ho, Er, Y and Yb, and more preferably La. The x value is preferably 0.001 or more, and more preferably 0.0015 or more, in terms of suppressing excessively high electrical resistance at room temperature. On the other hand, x is preferably 0.009 or less, in terms of preventing the electrical resistance at room temperature from becoming too high due to insufficient sintering.

The content of the BaTiO₃-based crystalline particles in which a part of Ba is substituted with the rare earth element in the ceramics is not particularly limited as long as it is determined to be the main component. However, it may preferably be 90% by mass or more, and more preferably 92% by mass or more, and even more preferably 94% by mass or more. The upper limit of the content of the BaTiO₃-based crystalline particles is not particularly limited, but it may generally be 99% by mass, and preferably 98% by mass.

In terms of reduction of the environmental load, it is desirable that the materials used for the outer peripheral wall 12 and the partition walls 15 are substantially free of lead (Pb). Specifically, the outer peripheral wall 12 and the partition walls 15 preferably have a Pb content of 0.01% by mass or less, and more preferably 0.001% by mass or less, and still more preferably 0% by mass. The lower Pb content can allow the air heated by contact with the heat-generating partition walls 15 or the like to be safely applied to organisms such as humans, for example. In the outer peripheral wall 12 and the partition walls 15, the Pb content is preferably less than 0.03% by mass, more preferably less than 0.01% by mass, and even more preferably 0% by mass, as converted to PbO. The lead content can be determined by ICP-MS (inductively coupled plasma mass spectrometry).

The Curie point of the material making up the outer peripheral wall 12 and the partition walls 15 is preferably in a temperature range where the resistance value is twice or more the resistance at room temperature (25° C.). If the Curie point is in such a temperature range, the current flowing through the air conditioning device 10 will be limited when the temperature of the air conditioning device 10 becomes high, so that any excessive heat generation of the air conditioning device 20 will be efficiently suppressed. Therefore, thermal deterioration of the adsorption layer 16 caused by excessive heat generation can be suppressed.

In terms of efficiently heating the adsorption layer 16, the material making up the outer peripheral wall 12 and the partition walls 15 preferably have a lower limit of a Curie point of 80° C. or more, more preferably 100° C. or more, even more preferably 110° C. or more, and still more preferably 125° C. or more. Further, in terms of safety as a component placed in the vehicle interior or near the vehicle interior, the upper limit of the Curie point is preferably 200° C. or more, more preferably 190° C. or more, even more preferably 180° C. or more, and still more preferably 150° C. or more.

The Curie point of the material making up the outer peripheral wall 12 and the partition walls 15 can be adjusted by the type and amount of shifter added. For example, the Curie point of barium titanate (BaTIO₃) is about 120° C., but the Curie point can be shifted to the lower temperature side by substituting a part of Ba and Ti with one or more of Sr, Sn and Zr.

As used herein, the Curie point is measured by the following method. A sample is attached to a sample holder for measurement, mounted in a measuring tank (e.g., MINI-SUBZERO MC-810P, from ESPEC). A change in electrical resistance of the sample as a function of a temperature when the temperature is increased from 10° C. is measured using a DC resistance meter (e.g., Multimeter 3478A, from JAPAN HEWLETT PACKARD, LLC). Based on an electrical resistance-temperature plot obtained by the measurement, a temperature at which the resistance value is twice the resistance value at room temperature (25° C.) is defined as the Curie point.

### (1-2. Adsorption Layer 16)

The adsorption layer 16 contains an adsorbent.

The adsorption layer 16 can be provided on the surfaces of the partition walls 15 (in the case of the outermost cells 14, the partition walls 15 that define the outermost cells 14 and the outer peripheral wall 12). By thus providing the adsorption layer 16, the moisture, carbon dioxide and the like are easily adsorbed during the adsorption mode, and the adsorption layer 16 can be easily heated during the desorption mode, so that the desorption target substances are easily separated.

The temperature of the adsorption layer 16 is preferably obtained by previously determining a relationship between at least one condition parameter and a temperature of the adsorption layer 16, the at least one condition parameter being selected from the temperature of the honeycomb structure 11, the resistance value of the honeycomb structure 11, the current value of the honeycomb structure 11, the heating time of the honeycomb structure 11, the temperature of the air passing through the honeycomb structure 11, and the amount of the components contained in the air passing through the honeycomb structure 11, and then measuring the condition parameter. Although it is difficult to directly measure the temperature of the adsorption layer 16 in the vehicle air conditioning system, the temperature of the adsorption layer 16 can be determined by measuring the condition parameter as described above.

The adsorbent contained in the adsorption layer 16 is preferably capable of adsorbing one or more selected from moisture, carbon dioxide and volatile components. Specifically, the adsorption layer 16 can contain at least one adsorbent that can adsorb these components. If one adsorbent can adsorb all the moisture, carbon dioxide and volatile components, the moisture, the carbon dioxide and the volatile components can be adsorbed by including only that adsorbent. By containing such an adsorbent, it is possible to obtain an effect of purifying the air.

The adsorbent contained in the adsorption layer 16 preferably has a function that can adsorb the adsorption target substances such as moisture and carbon dioxide at −20 to 60° C. and desorb the adsorption target substances at a temperature of higher than 60° C.

Examples of the adsorbent include, but not limited to, aluminosilicate, silica gel, silica, graphene oxide, polymer adsorbents, polystyrene sulfonic acid, zeolite, activated carbon, alumina, low-crystalline clay, amorphous aluminum silicate composites, and metal organic frameworks (MOFs). These may be used alone or in combination of two or more.

Examples of the aluminosilicate that can be preferably used herein include AFI type-, CHA type-, or BEA type-zeolite; porous clay minerals such as allophane and imogolite. Also, it is more preferable that the aluminosilicate is amorphous.

As the silica gel, type A silica gel is preferably used.

Examples of the polymer adsorbent that can be preferably used herein include a polymer adsorbent having a polyacrylic acid polymer chain. For example, sodium polyacrylate or the like can be used as the polymer adsorbent.

The metal organic framework is a crystalline hybrid material containing metal ions and organic molecules (organic ligands). The metal ions are preferably hydrophilic metal ions (for example, aluminum ions).

The volatile components in the air in the vehicle interior are, for example, volatile organic compounds (VOCs) and odor components other than the VOCs. Specific examples of the volatile components include ammonia, acetic acid, isovaleric acid, nonenal, formaldehyde, toluene, xylene, paradichlorobenzene, ethylbenzene, styrene, chlorpyrifos, di-n-butyl phthalate, tetradecane, and di-2-ethylhexyl phthalate, diazinon, acetaldehyde, 2-(1-methylpropyl)phenyl N-methylcarbamate, and the like.

The adsorption layer 16 can contain a catalyst. By containing the catalyst, it is possible to promote oxidation-reduction reaction and the like to purify carbon dioxide and/or volatile components. The catalyst having such a function includes metal catalysts such as Pt, Pd and Ag, and oxide catalysts such as CeO₂ and ZrO₂. The catalyst may be used alone or in combination of two or more types. The catalyst may also be used in combination with the functional material as described above.

The thickness of the adsorption layer 16 may be determined according to the size of the cells 14, and is not particularly limited. For example, from the viewpoint of ensuring sufficient contact with air, the thickness of the adsorption layer 16 is preferably 20 μm or more, more preferably 25 μm or more, and even more preferably 30 μm or more. On the other hand, from the viewpoint of suppressing separation of the adsorption layer 16 from the partition walls 15 and the outer peripheral wall 12, the thickness of the adsorption layer 16 is preferably 400 μm or less, more preferably 380 μm or less, and even more preferably 350 μm or less.

The thickness of the adsorption layer 16 is measured using the following procedure. Any cross section of the honeycomb structure 11 parallel to the flow path direction is cut out, and a cross-sectional image at magnifications of about 50 is acquired using a scanning electron microscope or the like. Also, this cross section is made to pass through the center of gravity position in the cross section orthogonal to the flow path of the honeycomb structure 11. The thickness of each adsorption layer 16 visually recognized from the cross-sectional image is calculated by dividing the cross-sectional area by the length of the cells 14 in the flow path direction. This calculation is performed for all the adsorption layers 16 visually recognized from the cross-sectional image, and an average value thereof is determined to be the thickness of the adsorption layer 16.

From the viewpoint of exerting a desired function in the air conditioning device 10, an amount of the adsorption layer 16 is preferably 50 to 500 g/L, more preferably 100 to 400 g/L, and even more preferably 150 to 350 g/L, based on the volume of the honeycomb structure 11. It should be noted that the volume of the honeycomb structure 11 is a value determined by the external dimensions of the honeycomb structure 11.

### (1-3. Pair of Electrodes 17a, 17b)

A pair of electrodes 17a, 17b may be provided on the first end face 13a and the second end face 13b of the honeycomb structure 11, respectively, as illustrated in FIG. 3A, although the positions of the electrodes 17a, 17b are not limited thereto. Also, the pair of electrodes 17a, 17b may be provided on the outer peripheral wall 12 parallel to the extending direction of the cells 14 of the honeycomb structure 11.

Applying a voltage between the pair of electrodes 17a, 17b allows the honeycomb structure 11 to generate heat by Joule heat.

The pair of electrodes 17a, 17b may employ, for example, a metal or alloy containing at least one selected from Cu, Ag, Al, Ni and Si, although not particularly limited thereto. It is also possible to use an ohmic electrode capable of ohmic contact with the outer peripheral wall 12 and/or the partition walls 15 which have the PTC property. The ohmic electrode may employ an ohmic electrode containing, for example, at least one selected from Al, Au, Ag and In as a base metal, and containing at least one selected from Ni, Si, Zn, Ge, Sn, Se and Te for n-type semiconductors as a dopant. Further, the pair of electrodes 17a, 17b may have a single-layer structure, or may have a laminated structure of two or more layers. When the pair of electrodes 17a, 17b have the laminated structure of two or more layers, the materials of the respective layers may be of the same type or of different types.

The thickness of the pair of electrodes 17a, 17b may be appropriately set according to the method for forming the pair of electrodes 17a, 17b. The method for forming the pair of electrodes 17a, 17b includes metal deposition methods such as sputtering, vapor deposition, electrolytic deposition, and chemical deposition. Alternatively, the pair of electrodes 17a, 17b can be formed by applying an electrode paste and then baking it, or by thermal spraying. Furthermore, the pair of electrodes 17a, 17b may be formed by joining metal sheets or alloy sheets.

Each of the thicknesses of the pair of electrodes 17a, 17b is, for example, about 5 to 80 μm for baking the electrode paste, and about 100 to 1000 nm for dry plating such as sputtering and vapor deposition, and about 10 to 100 μm for thermal spraying, and about 5 μm to 30 μm for wet plating such as electrolytic deposition and chemical deposition. Further, when joining the metal sheet or alloy sheet, each thickness is preferably about 5 to 100 μm.

### (1-4. Terminal 18)

The terminals 18 are connected to the pair of electrodes 17a, 17b, and provided on at least part of the pair of electrodes 17a, 17b. The provision of the terminals 18 facilitates connection to an external power source. The terminals 18 are connected to a conductor connected to the external power source.

The terminals 18 may be made of any material, including, but not particularly limited to, a metal, for example. The metal that can be used herein may include single metals, alloys, and the like, but from the viewpoint of corrosion resistance, electrical resistivity, and coefficient of linear expansion, it may preferably be alloys containing at least one selected from the group consisting of Cr, Fe, Co, Ni, Cu, Al, and Ti, and more preferably stainless steel, Fe—Ni alloy, and phosphor bronze.

The size and shape of the terminal 18 are not particularly limited. For example, as illustrated in FIG. 3A, the terminals 18 can be provided on the whole of the pair of electrodes 17a, 17b on the outer peripheral wall 12. Further, the terminals 18 may be provided on a part of the pair of electrodes 17a, 17b on the outer peripheral wall 12, or may be provided so as to extend toward an outer side than the outer edge of each of the pair of electrodes 17a, 17b on the outer peripheral wall 12. Further, the terminals 18 may be provided on a part of the pair of electrodes 17a, 17b on the partition walls 15, or may be provided so as to block a part of the cells 14.

Furthermore, the thickness of the terminal 18 is not particularly limited, but it is, for example, 0.01 to 10 mm, typically 0.05 to 5 mm.

The method of connecting the terminals 18 to the pair of electrodes 17a, 17b is not particularly limited as long as they are electrically connected. For example, they can be connected by diffusion bonding, a mechanical pressing mechanism, welding, or the like.

### (1-5. Method for Producing Air Conditioning Device 10)

The method for producing the air conditioning device 10 according to the embodiment of the disclosure is not particularly limited, and it can be performed according to a known method. Hereinafter, the method for producing the air conditioning device 10 according to an embodiment of the disclosure will be illustratively described.

A method for producing the honeycomb structure 11 forming the air conditioning device 10 includes a forming step and a firing step.

In the forming step, a green body containing a ceramic raw material including BaCO₃ powder, TiO₂ powder, and rare earth nitrate or hydroxide powder is formed to prepare a honeycomb formed body having a relative density of 60% or more.

The ceramic raw material can be obtained by dry-mixing the powders so as to have a desired composition.

The green body can be obtained by adding a dispersion medium, a binder, a plasticizer and a dispersant to the ceramic raw material and kneading them together. The green body may optionally contain additives such as shifters, metal oxides, property improving agents, and conductor powder.

The blending amount of the components other than the ceramic raw material is not particularly limited as long as the relative density of the honeycomb formed body is 60% or more.

As used herein, the “relative density of the honeycomb formed body” means a ratio of the density of the honeycomb formed body to the true density of the entire ceramic raw material. More particularly, the relative density can be determined by the following equation:

relative density of honeycomb formed body (%)=density of honeycomb formed body (g/cm³)/true density of entire ceramic raw material (g/cm³)×100.

The density of the honeycomb formed body can be measured by the Archimedes method using pure water as a medium. Further, the true density of the entire ceramic raw material can be obtained by dividing the total mass of the respective raw materials (g) by the total of the actual volumes of the respective raw materials (cm³).

Examples of the dispersion medium include water or a mixed solvent of water and an organic solvent such as alcohol, and more preferably water.

Examples of the binder include organic binders such as methyl cellulose, hydroxypropoxyl cellulose, hydroxyethyl cellulose, carboxymethyl cellulose, and polyvinyl alcohol. In particular, it is preferable to use methyl cellulose in combination with hydroxypropoxyl cellulose. The binder may be used alone, or in combination of two or more, but it is preferable that the binder does not contain an alkali metal element.

Examples of the plasticizer include polyoxyalkylene alkyl ethers, polycarboxylic acid-based polymers, and alkyl phosphate esters.

The dispersant that can be used herein includes surfactants such as polyoxyalkylene alkyl ether, ethylene glycol, dextrin, fatty acid soaps, and polyalcohol. The dispersant may be used alone or in combination of two or more.

The honeycomb formed body can be produced by extruding the green body. For the extrusion, a die having a desired overall shape, cell shape, partition wall thickness, cell density and the like can be used.

The relative density of the honeycomb formed body obtained by extrusion is 60% or more, and preferably 65% or more. By limiting the relative density of the honeycomb formed body to such a range, the honeycomb formed body can be densified and the electrical resistance at room temperature can be reduced. The upper limit of the relative density of the honeycomb formed body is not particularly limited, but it may generally be 80%, and preferably 75%.

The honeycomb formed body can be dried before the firing step. Non-limiting examples of the drying method include known drying methods such as hot air drying, microwave drying, dielectric drying, drying under reduced pressure, drying in vacuum, and freeze drying. Among these, a drying method that combines the hot air drying with the microwave drying or dielectric drying is preferable because the entire formed body can be rapidly and uniformly dried.

The firing step includes maintaining the formed body at a temperature of from 1150 to 1250° C., and then increasing the temperature to a maximum temperature of from 1360 to 1430° C. at a heating rate of 20 to 600° C./hour, and maintaining the temperature for 0.5 to 10 hours.

The maintaining of the honeycomb formed body at the maximum temperature of from 1360 to 1430° C. for 0.5 to 10 hours can provide the honeycomb structure 11 containing, as a main component, BaTiO₃-based crystal particles in which a part of Ba is substituted with the rare earth element.

Further, maintaining the temperature of the honeycomb formed body of 1150 to 1250° C. can allow the Ba₂TiO₄ crystal particles generated in the firing process to be easily removed, so that the honeycomb structure 11 can be densified.

Further, the heating rate of 20 to 600° C./hour from the temperature of 1150 to 1250° C. to the maximum temperature of 1360 to 1430° C. can allow 1.0 to 10.0% by mass of Ba₆Ti₁₇O₄₀ crystal particles to be formed in the honeycomb structure 11.

The amount of time when the honeycomb formed body is maintained at 1150 to 1250° C. is not particularly limited, but it may preferably be from 0.5 to 10 hours. Such a maintaining time can lead to stable and easy removal of Ba₂TiO₄ crystal particles generated in the firing process.

The firing step preferably includes maintaining the honeycomb formed body at 900 to 950° C. for 0.5 to 5 hours while the temperature is increased. Maintaining the honeycomb formed body at 900 to 950° C. for 0.5 to 5 hours can lead to sufficient decomposition of BaCO₃, so that a honeycomb structure 11 having a predetermined composition can be easily obtained.

Prior to the firing step, a degreasing step for removing the binder may be performed. The degreasing step may preferably be performed in an air atmosphere in order to decompose the organic components completely.

Also, the atmosphere of the firing step may preferably be the air atmosphere in terms of control of electrical characteristics and production cost.

A firing furnace used in the firing step and the degreasing step is not particularly limited, but it may be an electric furnace, a gas furnace, or the like.

The pair of electrodes 17a, 17b is formed on the honeycomb structure 11 thus obtained. The pair of electrodes 17a, 17b can be formed by metal deposition methods such as sputtering, vapor deposition, electrolytic deposition, and chemical deposition. Further, the pair of electrodes 17a, 17b can also be formed by applying an electrode paste and then baking it. Furthermore, the pair of electrodes 17a, 17b can also be formed by thermal spraying. The pair of electrodes 17a, 17b may be composed of a single layer, but may also be composed of a plurality of electrode layers having different compositions. A typical method for forming the pair of electrodes 17a, 17b will be described below.

First, an electrode slurry containing an electrode material, an organic binder, and a dispersion medium is prepared, and the first end face 13a or the second end face 13b of the honeycomb structure 11 is coated with the slurry. The dispersion medium can be water, an organic solvent (e.g., toluene, xylene, ethanol, n-butanol, ethyl acetate, butyl acetate, terpineol, dihydroterpineol, texanol, ethylene glycol monobutyl ether acetate, diethylene glycol monoethyl ether acetate, diethylene glycol monoethyl ether, diethylene glycol monobutyl ether acetate, diethylene glycol monobutyl ether) or a mixture thereof. An excess slurry on the periphery of the honeycomb structure 11 is removed by blowing and wiping. The slurry can be then dried to form the pair of electrodes 17a, 17b on the first end face 13a or the second end face 13b of the honeycomb structure 11. The drying can be performed while heating the honeycomb structure 11 to a temperature of about 120 to 600° C., for example. Although a series of steps of coating, slurry removal, and drying may be performed only once, the steps can be repeated multiple times to provide the pair of electrodes 17a, 17b having desired thicknesses.

The terminals 18 are then provided at predetermined positions of the pair of electrodes 17a, 17b, and the pair of electrodes 17a, 17b and the terminals 18 are connected to each other. As a method of connecting the pair of electrodes 17a, 17b to the terminals 18, the method described above can be used.

It should be noted that the terminals 18 may be placed after forming an adsorption layer 16 described below.

The adsorption layer 16 is then formed on the surfaces of the partition walls 15 and the like of the honeycomb structure 11.

Although the method for forming the adsorption layer 16 is not particularly limited, it can be formed, for example, by the following steps. The honeycomb structure 11 is immersed in a slurry containing an adsorbent, an organic binder, and a dispersion medium for a predetermined period of time, and an excess slurry on the end faces and the outer periphery of the honeycomb structure 11 is removed by blowing and wiping. The dispersion medium can be water, an organic solvent (e.g., toluene, xylene, ethanol, n-butanol, ethyl acetate, butyl acetate, terpineol, dihydroterpineol, texanol, ethylene glycol monobutyl ether acetate, diethylene glycol monoethyl ether acetate, diethylene glycol monoethyl ether, diethylene glycol monobutyl ether acetate, diethylene glycol monobutyl ether) or a mixture thereof. The slurry can be then dried to form the adsorption layer 16 on the surfaces of the partition walls 15 and the like. The drying can be performed while heating the honeycomb structure 11 to a temperature of about 120 to 600° C., for example. Although a series of steps of immersion, slurry removal, and drying may be performed only once, the steps can be repeated multiple times to provide the adsorption layer 16 having the desired thickness on the surfaces of the partition walls 15 and the like.

### (2. Air Conditioning Duct 20)

The air conditioning duct 20 is a flow path that can allow the air from the vehicle interior or the vehicle exterior to flow therethrough. The upstream side of the air conditioning duct 20 is connected to the vehicle interior or an outside air introduction port. The air conditioning duct 20 allows the air from the vehicle interior or vehicle exterior to flow therein, and also allows the air that has passed through the air conditioning device 10 to flow in the vehicle interior or flow out to the vehicle exterior. Therefore, the air conditioning duct 20 can have a structure that branches into a first flow path 20 that allows the air to flow into the vehicle interior on the downstream side of the air conditioning device 10, and a second flow path 20b that allows the air to be discharged to the vehicle exterior.

### (3. Valve 30)

The valve 30 may be configured to switch the flow of the air between the first flow path 20a and the second flow path 20b. The valve 30 can be provided at a branch portion between the first flow path 20a and the second flow path 12b in the air conditioning duct 20.

The valve 30 is not particularly limited as long as it is electrically driven and has the function of switching the flow path, and a solenoid valve, an electric valve, and the like can be used. For example, the valve 30 includes an opening/closing door supported by a rotating shaft and an actuator such as a motor that rotates the rotating shaft. The actuator can be configured to be controllable by the control unit 40.

### (4. Control Unit 40)

The control unit 40 controls the air conditioning device 10 and the valve 30. Further, the control unit 40 can also control the ventilation fan 60. The control unit 40 is electrically connected to the air conditioning device 10 and the ventilator 60 via the power source 50.

The control unit 40 can control the power source 50, thereby adjusting the heating state of the honeycomb structure 11 by controlling a voltage applying state to the pair of electrodes 17a, 17b of the air conditioning device 10. Further, the control unit 40 can also control the valve 30 so that the air flows through the first flow path 20a or the second flow path 20b. Furthermore, the control unit 40 can adjust the rotation speed of the ventilation fan 60, thereby controlling the flow velocity of the air flowing through the air conditioning duct 20.

The control unit 40 is generally an ECU (Engine (electronic) Control Unit), although not particularly limited thereto. The ECU is a CPU for executing various calculation processes, a ROM for storing programs and data required for its control, a RAM for temporarily storing results of calculations performed by the CPU, and input/output ports for inputting and outputting signals to and from the outside.

The control unit 40 is configured to execute the adsorption mode where the applied voltage from the power source 50 is turned off and the adsorption layer 16 of the air conditioning device 10 is not heated, and the desorption mode where the applied voltage from the power source 50 is turned on and the adsorption layer 16 of the air conditioning device 10 is heated.

In the desorption mode, the adsorption target substances such as moisture and carbon dioxide, adsorbed in the adsorption layer 16, are desorbed and discharged to the vehicle exterior through the second flow path 20b. However, in the initial stage where the adsorption mode has been shifted to the desorption mode, the temperature of the adsorption layer 16 is lower than or equal to the predetermined temperature, so that the adsorption target substance cannot be desorbed. Therefore, the valve 30 is switched so that the air flows into the second flow path 20b when the adsorption layer 16 exceeds the predetermined temperature. Such control allows the air with reduced or removed adsorption target substances during the period until the temperature of the adsorption layer 16 exceeds the predetermined temperature to flow into the vehicle interior without waste, while efficiently desorbing the adsorption target substances in the desorption mode.

In the adsorption mode, the adsorption target substances such as moisture and carbon dioxide in the air circulating from the vehicle interior or the vehicle exterior are adsorbed, and the air with reduced or removed adsorption target substances is returned to the vehicle interior through the first flow path 20a. However, in the initial stage when the desorption mode has been shifted to the adsorption mode, the temperature of the adsorption layer 16 is higher than the predetermined temperature, so that the adsorption target substances cannot be adsorbed. Therefore, it is preferable to switch the valve 30 so that the air flows into the first flow path 20a when the temperature of the adsorption layer 16 is lower than or equal to the predetermined temperature. Such control allows the adsorption target substances to be efficiently adsorbed in the adsorption mode while discharging the air containing the desorbed adsorption target substances to the vehicle exterior during the period until the temperature of the adsorption layer 16 is lower than or equal to the predetermined temperature.

From the viewpoint of stably performing the above control, it is desirable that the air conditioning device 10 be placed at a position close to the vehicle interior. Therefore, from the viewpoint of preventing electric shock and the like, it is preferable that the driving voltage of the air conditioning device 10 is 60V or less. Since the honeycomb structure 11 used in the air conditioning device 10 has a low electrical resistance at room temperature, the honeycomb structure 11 can be heated at the low driving voltage. It should be noted that the lower limit of the driving voltage is not particularly limited, but it may preferably be 10 V or more. If the driving voltage is less than 10V, the current during heating the honeycomb structure 11 becomes large, so that the conductor wire should be thick.

### (5. Power Source 50)

The power source 50 is for applying a voltage to the air conditioning device 10 (in particular, the pair of electrodes 17a, 17b). The power source 50 is electrically connected to the control unit 40, and adjusts the state of the voltage applied to the pair of electrodes 17a, 17b according to instructions from the control unit 40.

The power source 50 is not particularly limited, and a battery or the like can be used.

### (6. Ventilation Fan 60)

The ventilation fan 60 is a device for allowing the air from the vehicle interior or the vehicle exterior to flow into the air conditioning device 10, and is provided in the air conditioning duct 20. The position of the ventilation fan 60 is not limited, but it may be on the upstream side of the air conditioning device 10, for example, as shown in FIG. 1, or on the downstream side of the air conditioning device 10.

The ventilation fan 60 is electrically connected to the control unit 40 and can control the flow velocity of the air by adjusting the rotation speed according to instructions from the control unit 40.

### DESCRIPTION OF REFERENCE NUMERALS

10 air conditioning device
11 honeycomb structure
12 outer peripheral wall
13a first end face
13b second end face
14 cell
15 partition wall
16 adsorption layer
17a, 17b pair of electrodes
18 terminal
20 air conditioning duct
20a first flow path
20b second flow path
30 valve
40 control unit
50 power source
60 ventilation fan

1. A vehicle air conditioning system, comprising:
at least one air conditioning device comprising an adsorption portion containing an adsorbent configured to adsorb absorbent target substances at a temperature lower than or equal to a predetermined temperature and to desorb the adsorption target substances when the temperature exceeds the predetermined temperature, and a heating means configured to heat the adsorption portion;
an air conditioning duct having the air conditioning device provided therein and allowing air from a vehicle interior or a vehicle exterior to flow therethrough, the air conditioning duct having a first flow path for allowing the air to flow into the vehicle interior on a downstream side of the air conditioning device and a second flow path for discharging the air to the vehicle exterior;
a valve configured to switch the flow of the air between the first flow path and the second flow path; and
a control unit for controlling the air conditioning device and the valve,
wherein the control unit is configured to execute an adsorption mode where the heating means of the air conditioning device is not activated, and a desorption mode where the heating means of the air conditioning device is activated, and
wherein the control unit switches the valve so that the air flows into the second flow path at a stage when the temperature of the adsorption portion exceeds the predetermined temperature as the adsorption mode is shifted to the desorption mode.

2. The vehicle air conditioning system according to claim 1, wherein the control unit switches the valve so that the air flows into the first flow path at a stage when the temperature of the adsorption portion is lower than or equal to the predetermined temperature as the desorption mode is shifted to the adsorption mode.

3. The vehicle air conditioning system according to claim 1, wherein the switching of the valve as the adsorption mode is shifted to the desorption mode takes place within 60 seconds from the start of the desorption mode.

4. The vehicle air conditioning system according to claim 1, wherein the switching of the valve as the desorption mode is shifted to the adsorption mode takes place within 60 seconds from the start of the adsorption mode.

5. The vehicle air conditioning system according to claim 1, wherein the adsorption mode and the desorption mode are repeatedly and sequentially executed.

6. The air conditioning system according to claim 1, wherein the air conditioning device comprises:
a honeycomb structure having an outer peripheral wall and partition walls provided on an inner side of the outer peripheral wall, the partition walls defining a plurality of cells, each of the cells extending from a first end face to a second end face of the honeycomb structure to form a flow path for the air;
an adsorption layer comprising the adsorbent, the adsorption layer being provided on a surface of each of the partition walls; and
a pair of electrodes provided on the first end face and the second end face of the honeycomb structure, or on the outer peripheral wall parallel to the extending direction of the cells of the honeycomb structure.

7. The vehicle air conditioning system according to claim 6, wherein a temperature of the adsorption layer is obtained by previously determining a relationship between at least one condition parameter and the temperature of the adsorption layer, the at least one condition parameter being selected from a temperature of the honeycomb structure, a resistance value of the honeycomb structure, a current value of the honeycomb structure, a heating time of the honeycomb structure, a temperature of the air passing through the honeycomb structure, and amounts of components contained in the air passing through the honeycomb structure, and then measuring the condition parameter.

8. The vehicle air conditioning system according to claim 6, further comprising a power source for applying voltage to the air conditioning device.

9. The vehicle air conditioning system according to claim 6, wherein at least the partition walls of the honeycomb structure are made of a material having a positive temperature coefficient (PTC) property.

10. The vehicle air conditioning system according to claim 6, wherein the adsorbent is configured to adsorb at least one of moisture, carbon dioxide and volatile components.
